(19) United States
(12) Patent Application Publication
(10) Pub. No.: US 2017/0287524 A1
(43) Pub. Date: Oct. 5, 2017

(54) METHOD AND ELECTRONIC DEVICE FOR PROCESSING DYNAMIC IMAGE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Tianyu Jiang, Beijing (CN)

(21) Appl. No.: 15/245,743

(22) Filed: Aug. 24, 2016

Related U.S. Application Data
(63) Continuation of application No. PCT/CN2016/088859, filed on Jul. 6, 2016.

(30) Foreign Application Priority Data
Mar. 31, 2016 (CN) 201610196491.0

(51) Int. Cl. G11B 27/19; H04N 5/76; G10L 19/018; G11B 20/10

(52) U.S. Cl. CPC G11B 27/19; G11B 20/10527; H04N 5/76; G10L 19/018; G11B 2020/10546

(57) ABSTRACT

Disclosed are a method for processing a dynamic image and an electronic device thereof. The method includes: taking a dynamic image and meantime recording a sound; extracting a sound print feature from recorded sound information; and writing an extracted sound print feature into the dynamic image, and performing sound print tagging on the dynamic image. According to the embodiments of the present disclosure, sound print tagging on the dynamic image is implemented, retrieving the dynamic image by category and quick match and query based on the sound print feature are implemented, which makes operations for users to retrieve an image more efficiently and intuitively.

### CROSS REFERENCE TO RELATED APPLICATIONS

This application is a continuation of International Application No. PCT/CN2016/088859, filed on Jul. 6, 2016, which is based upon and claims priority to Chinese Patent Application No. 201610196491.0, filed on Mar. 31, 2016, the entire contents of which are incorporated herein by reference.

### TECHNICAL FIELD

The present disclosure relates to the technical field of dynamic image processing, and more particularly, to a method and electronic device for processing dynamic image.

### BACKGROUND

After many mobile device manufacturers presented new image media formats such as Zoe and LivePhoto, it is very possible that dynamic image formats will replace existing static image formats and become the next important competition segment in the mobile device technology innovation field. An existing dynamic image records only image information within a shooting scope and purely records an original digital media signal, without considering sound content information under a shooting scenario; therefore, in the field of dynamic image format processing, there is much space to improve the use experience of users.

### SUMMARY

The present disclosure provides a method for processing a dynamic image and an electronic device thereof, so as to solve the technical problem that an existing dynamic image records only image information within a shooting scope and purely records an original digital media signal without considering sound content information under a shooting scenario.

In a first aspect, embodiments of the present disclosure provide a method for processing a dynamic image includes:

taking a dynamic image, and recording a sound during a process of taking the dynamic image;

extracting a sound print feature from recorded sound information; and

writing an extracted sound print feature into the dynamic image, and performing sound print tagging on the dynamic image.

In a second aspect, embodiments of the present disclosure provide a non-volatile computer storage medium which stores computer executable instructions, wherein the computer executable instructions are executed to:

take a dynamic a dynamic image according to an image taking instruction, and record a sound during a process of taking the dynamic image according to the image taking instruction;

extract a sound print feature from recorded sound information according to a sound print extraction instruction; and

write an extracted sound print feature into the dynamic image according to a sound print tagging instruction, and perform sound print tagging on the dynamic image.

In a third aspect, embodiments of the present disclosure further provide an electronic device, configured to perform the method for processing a dynamic image, including:

at least one processor; and

a memory communicably connected to the at least one processor; wherein

the memory stores instructions executable by the at least one processor, wherein, the instructions, when being executed by the at least one processor, causes the at least one processor to:

take a dynamic a dynamic image according to an image taking instruction, and record a sound during a process of taking the dynamic image according to the image taking instruction;

extract sound print feature from recorded sound information according to a sound print extraction instruction; and

write an extracted sound print feature into the dynamic image according to a sound print tagging instruction, and perform sound print tagging on the dynamic image.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for processing a dynamic image according to an embodiment of the present disclosure;

FIG. 2 is a schematic diagram illustrating extracting a sound print feature according to an embodiment of the present disclosure;

FIG. 3 is a schematic structural diagram illustrating a system for processing a dynamic image according to an embodiment of the present disclosure; and

FIG. 4 is a schematic structural diagram illustrating hardware of an electronic device for performing the method for processing a dynamic image according to an embodiment of the present disclosure.

### DETAILED DESCRIPTION

In order to make the present disclosure easy to understand, the following describes the present disclosure more fully with reference to relevant accompanying drawings. The accompanying drawings show preferred embodiments of the present disclosure. However, the present disclosure may be implemented in multiple manners, and is not limited to embodiments described herein. On the contrary, the purpose of providing these embodiments is to more thoroughly and fully understand the disclosure of the present disclosure.

Unless otherwise specified, all technical and scientific terms used herein have the same meanings as commonly understood by a person skilled in the technical field of the present disclosure. The terms used in the description of the present disclosure are merely intended to describe specific embodiments of the present disclosure, and are not intended to limit the present disclosure.

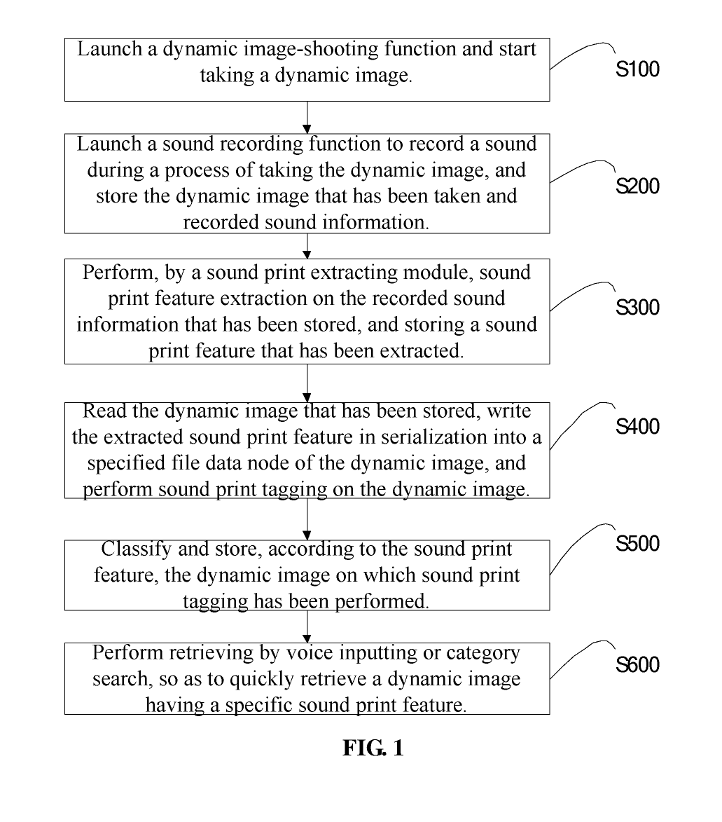

Referring to FIG. 1, FIG. 1 is a flowchart illustrating a method for processing a dynamic image according to an embodiment of the present disclosure. The method for processing a dynamic image according to the present disclosure includes the following steps:

Step 100: launching a dynamic image-shooting function and start taking a dynamic image.

Step 200: launching a sound recording function to record a sound during a process of taking the dynamic image, and store the dynamic image that has been taken and recorded sound information.

In step 200, according to this embodiment of the present disclosure, the dynamic image is stored in a form of Thumbnail+MOV (thumbnail), where an image is from Preview (preview) data of a camera, multiple frames of image data are encoded to generate an MOV, and an image at a center time axis is cut as the Thumbnail. An MOV format (QuickTime file format, which is an audio and video file format developed by Apple company, and is used to store a common digital media type) that is recorded by default contains a sound source with a video length of 4 seconds, and the recorded information includes a voice, an ambient sound, or a noise.

Step 300: performing, by a sound print extracting module, sound print feature extraction on the recorded sound information that has been stored, and storing a sound print feature that has been extracted.

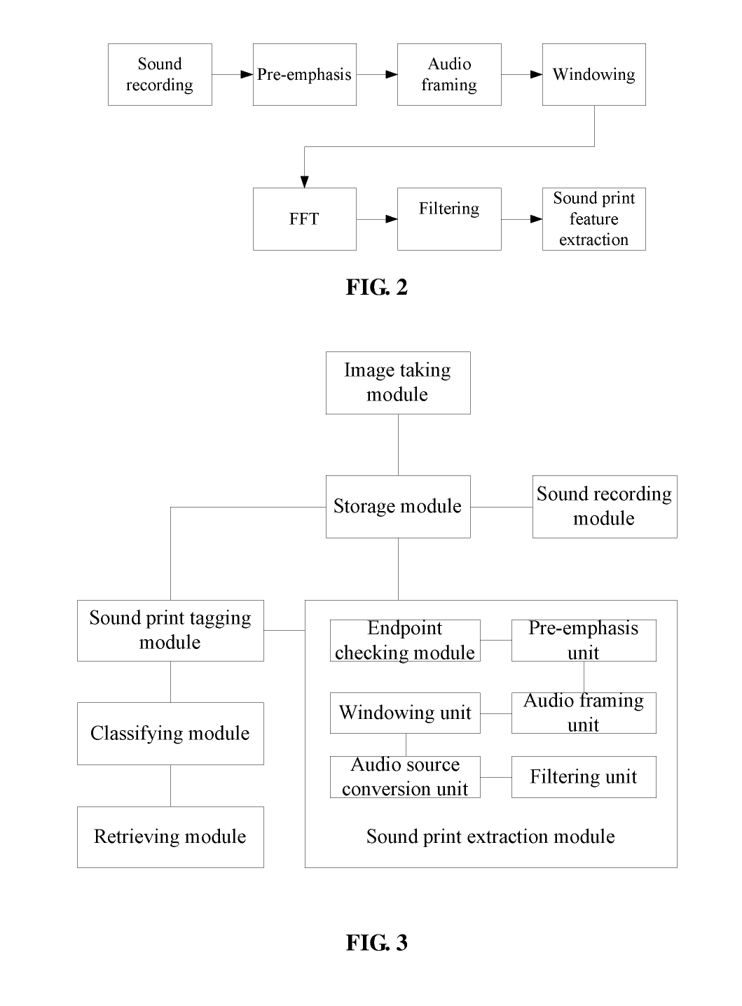

In step 300, according to this embodiment of the present disclosure, a special segment of media information is used to store the sound print feature. Specifically, as shown in FIG. 2, FIG. 2 is a schematic diagram illustrating extracting a sound print feature according to an embodiment of the present disclosure. A process of extracting a sound print feature according to this embodiment of the present disclosure includes the following steps:

Step 301: endpoint checking: checking for valid sound source data entry.

Step 302: pre-emphasis: performing differential and filtering processing on entered sound source data.

In step 302, an algorithm formula for pre-emphasis filtering is:

H(Z)=1− [symbol] (1)

Step 303: audio framing: performing discretization processing on a streaming sound source.

In step 303, in order to retain some detail features of the sound source, especially special sound quality of some environment scenarios, and in consideration of a size of data volume to be processed, in the present disclosure, 1 Channel 44100 Hz sampling standard is selected. According to a rule for audio processing, a duration of an audio frame is commonly controlled at about 20-30 ms; therefore, the number of sampling points for a single audio frame may be determined to 1024, which actually corresponds to a duration 1024÷44100×1000 ≈ 2.

Step 304: windowing processing: performing windowing processing on frame data by selecting a common Hamming window.

In step 304, after Hamming windowing processing is performed on each frame of audio data S(n) on which framing processing has been performed, data S′(n)=S(n)× [symbol] S′(n)=S(n)×W(n) is obtained, where W(n). W is in the following form:

$$W ( n , a ) = ( 1 - a ) - a \times cos [ \frac{2 π n}{N - 1} ] , 0 \leq n \leq N - 1 , a = 0.48 \qquad ( 2 )$$

Step 305: FFT (Fast Fourier Transformation, Fast Fourier Transformation): converting a time domain sound source into frequency domain energy.

In step 305, the time domain sound source is converted into frequency domain data by using Fast Fourier Transformation at the atomic operation level, where a conversion formula is:

$${X}_{a} ( k ) = {\sum }_{n = 0}^{N - 1} x ( n ) {e}^{- \frac{j 2 π k}{N}} , 0 \leq k \leq N \qquad ( 3 )$$

Step 306: performing band-pass filtering and sound print feature extraction on a sound source.

In step 306, filtering and sound print feature extraction are performed by using a specific filter and extraction algorithm with respect to different sound source features required for analysis, for example: for a voice feature, a triangle band-pass filter +DCT may be used to collect an MFCC coefficient feature; and for an ambient sound, a logarithmic filter+a wavelet transformation may be used to collect a Jaccard coefficient bit feature.

Step 400: reading the dynamic image that has been stored, write the extracted sound print feature in serialization into a specified file data node of the dynamic image, and perform sound print tagging on the dynamic image.

Step 500: classifying and storing, according to the sound print feature, the dynamic image on which sound print tagging has been performed.

In step 500, a classifying manner for classifying, according to the sound print feature, the dynamic image on which sound print tagging has been performed includes voice feature classification, ambient sound feature classification, or noise feature classification.

Step 600: performing retrieving by voice inputting or category search, so as to quickly retrieve a dynamic image having a specific sound print feature.

In step 600, a voice feature may be quickly indexed directly by performing recognition according to a similarity of input voice; an ambient sound feature or a noise feature that is more complex and another sound feature shall be classified according to features such as a sound-making object, a scenario location, sound strength, etc., and search shall be performed according to categories.

Referring to FIG. 3, FIG. 3 is a schematic structural diagram illustrating a system for processing a dynamic image according to an embodiment of the present disclosure. The system for processing a dynamic image according to an embodiment of the present disclosure includes an image taking module, a sound recording module, a storage module, a sound print extracting module, a sound print tagging module, a classifying module, and a retrieving module; wherein:

the image taking module is configured to take a dynamic image;

the sound recording module is configured to record a sound during a process of taking the dynamic image;

the storage module is configured to store the dynamic image that has been taken and the recorded sound information; and

the sound print extracting module is configured to extract a sound print feature from recorded sound information, and store the sound print feature that has been extracted. Specifically, the sound print extracting module further includes an endpoint checking unit, a pre-emphasis unit, an audio framing unit, a windowing unit, an audio source conversion unit, and a filtering unit; wherein:

the endpoint checking unit is configured to check for valid sound source data entry;

the pre-emphasis unit is configured to perform differential and filtering processing on entered sound source data; An algorithm formula for pre-emphasis filtering is:

H(Z)=1− [symbol] (1)

the audio framing unit is configured to perform discretization processing on a streaming sound source; In order to retain some detail features of the sound source, especially special sound quality of some environment scenarios, and in consideration of a size of data volume to be processed, in the present disclosure, 1 Channel 44100 Hz sampling standard is selected. According to a rule for audio processing, a duration of an audio frame is commonly controlled at about 20-30 ms; therefore, the number of sampling points for a single audio frame may be determined to 1024, which actually corresponds to a duration 1024÷44100×1000 ≈ 2.

the windowing unit is configured to perform windowing processing on frame data by using a Hamming window; After Hamming windowing processing is performed on each frame of audio data S(n) on which framing processing has been performed, data

S′(n)=S(n)× [symbol] S′(n)=S(n)×W(n) is obtained, where W(n). W is in the following form:

$$W ( n , a ) = ( 1 - a ) - a \times cos [ \frac{2 π n}{N - 1} ] , 0 \leq n \leq N - 1 , a = 0.48 \qquad ( 2 )$$

the audio source conversion unit is configured to convert a time domain sound source into frequency domain energy by using FFT; The time domain sound source is converted into frequency domain data by using Fast Fourier Transformation at the atomic operation level, where a conversion formula is:

$${X}_{a} ( k ) = {\sum }_{n = 0}^{N - 1} x ( n ) {e}^{- \frac{j 2 π k}{N}} , 0 \leq k \leq N \qquad ( 3 )$$

the filtering unit is configured to perform band-pass filtering and sound print feature extraction on a sound source. Filtering and sound print feature extraction are performed by using a specific filter and extraction algorithm with respect to different sound source features required for analysis, for example: for a voice feature, a triangle band-pass filter +DCT may be used to collect an MFCC coefficient feature; and for an ambient sound, a logarithmic filter+a wavelet transformation may be used to collect a Jaccard coefficient bit feature.

The sound print tagging module is configured to read the dynamic image that has been stored, write the extracted sound print feature in serialization into a specified file data node of the dynamic image, and perform sound print tagging on the dynamic image.

The classifying module is configured to classify and store, according to the sound print feature, the dynamic image on which sound print tagging has been performed. A classifying manner for classifying, according to the sound print feature, the dynamic image on which sound print tagging has been performed includes voice feature classification, ambient sound feature classification, or noise feature classification.

The retrieving module is configured to perform retrieving by voice inputting or category search, so as to quickly retrieve a dynamic image having a specific sound print feature. A voice feature may be quickly indexed directly by performing recognition according to a similarity of input voice; an ambient sound feature or a noise feature that is more complex and another sound feature shall be classified according to features such as a sound-making object, a scenario location, sound strength, etc., and search shall be performed according to categories.

An embodiment of the present disclosure provides a non-volatile computer storage medium, wherein the computer storage medium stores computer executable instructions, which may be executed to perform the method for processing a dynamic image according to any one of the above method embodiments.

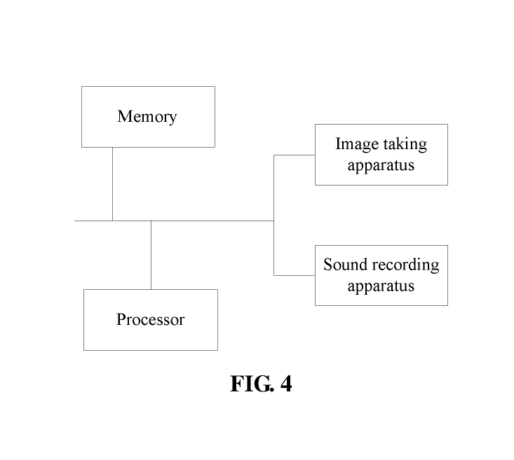

Referring to FIG. 4, a schematic structural diagram illustrating hardware of an electronic device for performing the method for processing a dynamic image according to an embodiment of the present disclosure is given.

The electronic device includes at least one processor and a memory, and FIG. 4 uses one processor as an example.

The electronic device for performing the method for processing a dynamic image may further include: an image taking apparatus and a sound recording apparatus. The image taking apparatus may be configured to taken a dynamic image, and the sound recording apparatus may be configured to record sound information such as a voice, an ambient sound, or a noise.

The processor, the memory, the image taking apparatus and the sound recording apparatus may be connected to each other via a bus or in another manner. FIG. 4 uses connection via a bus as an example for description.

The memory, as a non-volatile computer readable storage medium, may be configured to store non-volatile software programs, non-volatile computer executable programs and modules, for example, the program instructions/modules corresponding to the methods for processing a dynamic image in the embodiments of the present disclosure (for example, the sound print tagging module, the classifying module, the retrieving module and the like as illustrated in FIG. 3). The non-volatile software programs, instructions and modules stored in the memory, when being executed, cause the processor 610 to perform various function disclosures and data processing of a server, that is, performing the methods for processing a dynamic image in the above method embodiments.

The memory may also include a program storage area and a data storage area. The program storage area may store an operating system and an disclosure implementing at least one function. The data storage area may store the dynamically taken image and recorded sound information. In addition, the memory may include a high speed random access memory, or include a non-volatile memory, for example, at least one disk storage device, a flash memory device, or another non-volatile solid storage device. In some embodiments, the memory optionally includes memories remotely configured relative to the processor. These memories may be connected to the apparatus for processing item operations over a network. The above examples include, but not limited to, the Internet, Intranet, local area network, mobile communication network and a combination thereof.

The one or more modules are stored in the memory, and when being executed by the one or more processors 610, perform the method for processing a dynamic image in any of the above method embodiments.

The product may perform the method according to the embodiments of the present disclosure, has corresponding function modules for performing the method, and achieves the corresponding beneficial effects.

In the method for processing a dynamic image and the electronic device thereof according to embodiments of the present disclosure, real-time calculation is performed and a sound print feature of a scenario for taking a dynamic image is extracted; the sound print feature is written into the dynamic image to implement sound print tagging on the dynamic image; and the dynamic image is classified according to the sound print feature to achieve the objective of retrieving the dynamic image by category and perform quick match and query based on the sound print feature, which makes operations for users to retrieve an image more efficiently and intuitively.

The above embodiments are preferred embodiments of the present disclosure; however, embodiments of the present disclosure are not limited to the above embodiments. Any other change, amendment, alternation, combination, or simplification without departing from the spirit and principle of the present disclosure shall be equivalent replacements, and shall fall within the protection scope of the present disclosure.

What is claimed is:

1. A method for processing a dynamic image, applied to an electronic device, the method comprising:
taking a dynamic image, and recording a sound during a process of taking the dynamic image;
extracting a sound print feature from recorded sound information; and
writing an extracted sound print feature into the dynamic image, and performing sound print tagging on the dynamic image.

2. The method for processing a dynamic image according to claim 1, wherein the taking a dynamic image, and recording a sound during a process of taking the dynamic image further comprises: storing the dynamic image that has been taken and the recorded sound information; wherein a storage form of the dynamic image is a thumbnail, and the recorded sound information comprises a voice, an ambient sound, or a noise.

3. The method for processing a dynamic image according to claim 1, wherein a method for extracting the sound print feature comprises the following steps:
checking for valid sound source data entry;
performing differential and filtering processing on entered sound source data;
performing discretization processing on a streaming sound source;
performing windowing processing on frame data by using a Hamming window;
converting a time domain sound source into frequency domain energy by fast Fourier transform; and
performing band-pass filtering and sound print feature extraction on a sound source.

4. The method for processing a dynamic image according to claim 1, wherein a manner in which the extracted sound print feature is written into the dynamic image is: reading the dynamic image that has been stored, and writing the extracted sound print feature in serialization into a specified file data node of the dynamic image.

5. The method for processing a dynamic image according to claim 4, wherein after the writing an extracted sound print feature into the dynamic image, and performing sound print tagging on the dynamic image, the method further comprises: classifying and storing, according to the sound print feature, the dynamic image on which sound print tagging has been performed; and a manner for the classifying comprises voice feature classification, ambient sound feature classification, or noise feature classification.

6. The method for processing a dynamic image according to claim 5, wherein after the writing an extracted sound print feature into the dynamic image, and performing sound print tagging on the dynamic image, the method further comprises: retrieving a dynamic image having a specific sound print feature by voice inputting or category search.

7. A non-volatile computer storage medium storing computer executable instructions, wherein the computer instructions are executed to:
take a dynamic a dynamic image according to an image taking instruction, and record a sound during a process of taking the dynamic image according to the image taking instruction;
extract a sound print feature from recorded sound information according to a sound print extraction instruction;
write an extracted sound print feature into the dynamic image according to a sound print tagging instruction, and perform sound print tagging on the dynamic image.

8. The non-volatile computer storage medium storing computer executable instructions according to claim 7, wherein upon the taking a dynamic a dynamic image according to an image taking instruction, and recording a sound during a process of taking the dynamic image according to the image taking instruction, the computer executable instructions are further executed to:
store the dynamic image that has been taken and the recorded sound information; wherein a storage form of the dynamic image is a thumbnail, and the recorded sound information comprises a voice, an ambient sound, or a noise.

9. The non-volatile computer storage medium storing computer executable instructions according to claim 7, wherein the extracting a sound print feature from recorded sound information according to a sound print extraction instruction comprises
checking for valid sound source data entry according to an endpoint checking instruction;
performing differential and filtering processing on entered sound source data according to a pre-emphasizing instruction;
performing discretization processing on a streaming sound source according to an audio framing instruction;
performing windowing processing on frame data by using a Hamming window according to a windowing instruction;
converting a time domain sound source into frequency domain energy by fast Fourier transform according to a sound source conversion instruction; and
performing band-pass filtering and sound print feature extraction on a sound source according to a filtering instruction.

10. The non-volatile computer storage medium storing computer executable instructions according to claim 7, wherein a manner in which the extracted sound print feature is written into the dynamic image is:
reading the dynamic image that has been stored, and writing the extracted sound print feature in serialization into a specified file data node of the dynamic image.

11. The non-volatile computer storage medium storing computer executable instructions according to claim 7, wherein upon the writing an extracted sound print feature into the dynamic image, and performing sound print tagging on the dynamic image, the computer executable instructions are further executed to:
classify and store, according to the sound print feature, the dynamic image on which sound print tagging has been performed includes voice feature classification, ambient sound feature classification, or noise feature classification.

12. The non-volatile computer storage medium storing computer executable instructions according to claim 11, wherein upon the writing an extracted sound print feature into the dynamic image, and performing sound print tagging on the dynamic image, the computer executable instructions are further executed to:
retrieve a dynamic image having a specific sound print feature by voice inputting or category search.

13. An electronic device configured to perform a method for processing a dynamic image, comprising:
at least one processor; and
a memory communicably connected to the at least one processor; wherein
the memory stores instructions executable by the at least one processor, wherein, the instructions, when being executed by the at least one processor, causes the at least one processor to:
take a dynamic a dynamic image according to an image taking instruction, and record a sound during a process of taking the dynamic image according to the image taking instruction;
extract a sound print feature from recorded sound information according to a sound print extraction instruction;
write an extracted sound print feature into the dynamic image according to a sound print tagging instruction, and perform sound print tagging on the dynamic image.

14. The electronic device according to claim 13, wherein upon the taking a dynamic a dynamic image according to an image taking instruction, and recording a sound during a process of taking the dynamic image according to the image taking instruction, the at least one processor is further caused to:
store the dynamic image that has been taken and the recorded sound information; wherein a storage form of the dynamic image is a thumbnail, and the recorded sound information comprises a voice, an ambient sound, or a noise.

15. The electronic device according to claim 13, the extracting a sound print feature from recorded sound information according to a sound print extraction instruction comprises:
checking for valid sound source data entry according to an endpoint checking instruction;
performing differential and filtering processing on entered sound source data according to a pre-emphasizing instruction;
performing discretization processing on a streaming sound source according to an audio framing instruction;
performing windowing processing on frame data by using a Hamming window according to a windowing instruction;
converting a time domain sound source into frequency domain energy by fast Fourier transform according to a sound source conversion instruction; and
performing band-pass filtering and sound print feature extraction on a sound source according to a filtering instruction.

16. The electronic device according to claim 13, wherein a manner in which the extracted sound print feature is written into the dynamic image is:
reading the dynamic image that has been stored, and writing the extracted sound print feature in serialization into a specified file data node of the dynamic image.

17. The electronic device according to claim 16, wherein upon the writing an extracted sound print feature into the dynamic image, and performing sound print tagging on the dynamic image, the at least one processor is further caused to:
classify and store, according to the sound print feature, the dynamic image on which sound print tagging has been performed includes voice feature classification, ambient sound feature classification, or noise feature classification.

18. The electronic device according to claim 17, wherein upon the writing an extracted sound print feature into the dynamic image, and performing sound print tagging on the dynamic image, the at least one processor is further caused to:
retrieve a dynamic image having a specific sound print feature by voice inputting or category search.
